(19) United States
(12) Patent Application Publication
(10) Pub. No.: US 2018/0232558 A1
(43) Pub. Date: Aug. 16, 2018

(54) METHOD FOR PERFORMING INTERACTION AND ELECTRONIC DEVICE USING THE SAME

(71) Applicant: Samsung Electronics Co., Ltd., Gyeonggi-do (KR)

(72) Inventors: Hansoo Jung, Gyeonggi-do (KR); Kyuhyung Choi, Seoul (KR); Nawoong Han, Seoul (KR)

(73) Assignee: Samsung Electronics Co., Ltd.

(21) Appl. No.: 15/897,581

(22) Filed: Feb. 15, 2018

(30) Foreign Application Priority Data
Feb. 15, 2017 (KR) 10-2017-0020488

(51) Int. Cl. G06K 9/00; G06F 3/0488; G06F 3/0481

(52) U.S. Cl. CPC G06K 9/00073; G06F 3/04815; G06F 3/04883

(57) ABSTRACT

An electronic device is provided which includes a fingerprint sensor; and a processor configured to receive a first input of a fingerprint from a user, register, based on the first input, feature information corresponding to the fingerprint, after registering the feature information, receive a second input of at least a part of the fingerprint from the user, identify, based on the second input, location information on at least the part of the fingerprint, corresponding to the second input, that corresponds to a portion in the feature information, and perform at least one interaction based on the location information.

### PRIORITY

This application is based on and claims priority under 35 U.S.C. § 119 to Korean Patent Application No. 10-2017-0020488, filed on Feb. 15, 2017, in the Korean Intellectual Property Office, the disclosure of which is incorporated by reference herein in its entirety.

### BACKGROUND

### 1. Field

The present disclosure relates generally to a method for performing an interaction based on fingerprints and an electronic device using the same.

### 2. Description of Related Art

An electronic device has advanced into a portable terminal, such as a smart phone, that can provide various functions to a user through applications. The electronic device can sense a user's fingerprint, and can provide various functions based on the sensed fingerprint.

In general, if an electronic device senses a fingerprint, it mostly corresponds to a case where the sensed fingerprint is used for user authentication. For example, although the user's fingerprint is sensed at various angles, such sensing of the fingerprint may be limited to identification of whether the sensed fingerprint is a pre-registered user's fingerprint.

### SUMMARY

According to an embodiment of the present disclosure, an electronic device can identify to what portion of a pre-registered fingerprint the sensed fingerprint corresponds based on the pre-registered fingerprint. Further, the electronic device can perform various interactions in various applications based on the identified portion.

According to an embodiment of the present disclosure, an electronic device includes a fingerprint sensor; and a processor configured to receive a first input of a fingerprint from a user, register, based on the first input, feature information corresponding to the fingerprint, after registering the feature information, receive a second input of at least a part of the fingerprint from the user, identify, based on the second input, location information on at least the part of the fingerprint, corresponding to the second input, that corresponds to a portion in the feature information, and perform at least one interaction based on the location information.

According to an embodiment of the present disclosure, a method for an electronic device includes receiving a first input of a fingerprint from a user; registering, based on the first input, feature information corresponding to the fingerprint; receiving a second input of at least a part of the fingerprint from the user, after registering the feature information; identifying, based on the second input, location information on at least the part of the fingerprint, corresponding to the second input, that corresponds to which portion in the feature information; and performing at least one interaction based on the location information.

### BRIEF DESCRIPTION OF THE DRAWINGS

The above and other aspects, features, and advantages of embodiments of the present disclosure will be more apparent from the following description taken in conjunction with the accompanying drawings, in which:

FIG. 1 is a block diagram illustrating an electronic device in a network environment, according to various embodiments;

FIG. 2 is a block diagram of an electronic device, according to various embodiments;

FIG. 3 is a block diagram illustrating a program module, according to various embodiments;

FIG. 4 is a diagram illustrating a fingerprint-based interaction system, according to various embodiments;

FIG. 5 is a flowchart illustrating a method for performing at least one interaction by sensing rolling of a fingerprint on an electronic device, according to various embodiments;

FIG. 6 is a diagram illustrating that an electronic device can perform stereoscopic formation of a fingerprint, according to various embodiments;

FIG. 7 is a diagram illustrating that an electronic device can identify to what portion in a pre-registered fingerprint a sensed fingerprint corresponds based on a state where the fingerprint is put, according to various embodiments;

FIG. 8 is a diagram illustrating a method in which an electronic device configures a core of a fingerprint and a method in which the electronic device identifies the degree of inclination of a sensed fingerprint as a part of the sensed fingerprint becomes apart based on the core, according to various embodiments;

FIG. 9A is a diagram illustrating a method in which a web application of an electronic device displays at least one window through a tab function, according to various embodiments;

FIGS. 9B and 9C are diagrams illustrating a method in which a web application of an electronic device displays at least one window through an input of a fingerprint, according to various embodiments;

FIG. 10A is a diagram illustrating a method in which a contact us application of an electronic device searches for contact information through a drag input and a tap input, according to various embodiments;

FIG. 10B is a diagram illustrating a method in which a contact us application of an electronic device searches for contact information through an input of a fingerprint, according to various embodiments;

FIG. 11A is a diagram illustrating a method in which an electronic device identifies a notification list through a drag input, according to various embodiments;

FIG. 11B is a diagram illustrating a method in which an electronic device identifies in detail at least one notification in a notification list through an input of a fingerprint, according to various embodiments;

FIG. 12 is a diagram illustrating a method in which an application of the electronic device stereoscopically displays an object through an input of a fingerprint, according to various embodiments;

FIG. 13 is a diagram illustrating a method in which an application of the electronic device stereoscopically displays a geographical element through an input of a fingerprint, according to various embodiments;

FIGS. 14A and 14B are diagrams illustrating a method in which an electronic device simultaneously performs location movement and viewpoint movement through an input of a fingerprint, according to various embodiments;

FIG. 15 is a flowchart illustrating a method in which an electronic device performs at least one interaction by sensing location movement and rolling of a fingerprint, according to various embodiments; and

FIG. 16 is a diagram illustrating a method in which an electronic device adjusts a viewpoint in a stereoscopic space through an input of a fingerprint, according to various embodiments.

### DETAILED DESCRIPTION

Hereinafter, various embodiments of the present disclosure are described in greater detail with reference to the accompanying drawings. While the present disclosure may be embodied in many different forms, specific embodiments of the present disclosure are shown in the drawings and are described herein in detail, with the understanding that the present disclosure is not to be considered to be limited thereto. The same reference numerals are used throughout the drawings to refer to the same or like parts. The expressions “comprising” or “may comprise” used in the present disclosure indicate the presence of a corresponding function, operation, or element and do not limit an additional function, operation, or element. The terms “comprise” or “have” used herein indicate the presence of a characteristic, a numeral, a step, an operation, an element, a component, or a combination thereof described in the disclosure and do not exclude the presence or addition of another characteristic, numeral, step, operation, element, component, or combination thereof.

In the present disclosure, the term “or” includes any combination or the entire combination of all words listed together. For example, “A or B” may include A, B, or A and B. The term “and/or” covers a combination of a plurality of items, or any of the plurality of items.

Unless defined differently, terms including a technical term and a scientific term used herein have the same meaning as may be generally understood by a person skilled in the art. It is understood that generally using terms defined in a dictionary have a meaning corresponding to that of a context of related technology, and are not understood to have an ideal or excessively formal meaning unless explicitly defined.

In the present disclosure, an electronic device may have a communication function. For example, an electronic device may be a smart phone, a tablet personal computer (PC), a mobile phone, a video phone, an e-book reader, a desktop PC, a laptop PC, a netbook computer, a personal digital assistant (PDA), a portable multimedia player (PMP), a motion picture experts group (MPEG-1 or MPEG-2) audio layer 3 (MP3) player, a portable medical device, a digital camera, or a wearable device, such as an head-mounted device (HMD) in the form of electronic glasses, electronic clothes, an electronic bracelet, an electronic necklace, an electronic accessory, or a smart watch, etc.

According to various embodiments, an electronic device may be a smart home appliance that involves a communication function, such as a television (TV), a digital versatile disk (DVD) player, audio equipment, a refrigerator, an air conditioner, a vacuum cleaner, an oven, a microwave, a washing machine, an air cleaner, a set-top box, a TV box (e.g., Samsung HomeSync™, Apple TV™, and Google TV™), a game console, an electronic dictionary, an electronic key, a camcorder, or an electronic picture frame, etc., but is not limited thereto.

According to various embodiments, an electronic device may be a medical device (e.g., a magnetic resonance angiography (MRA) device, a magnetic resonance imaging (MRI) device, a computed tomography (CT) device, and an ultrasonography device), a navigation device, a global positioning system (GPS) receiver, an event data recorder (EDR), an flight data recorder (FDR), a car infotainment device, electronic equipment for ship (e.g., a marine navigation system or a gyrocompass), avionics, security equipment, or an industrial or home robot, etc., but is not limited thereto.

According to various embodiments, an electronic device may be furniture, or part of a building or construction having a communication function, an electronic board, an electronic signature receiving device, a projector, or various measuring instruments (e.g., a water, electric, gas, or a wave meter), etc., but is not limited thereto. An electronic device disclosed herein may be one of the above-mentioned devices or any combination thereof. As is well understood by those skilled in the art, the above-mentioned electronic devices are not to be considered as a limitation of the present disclosure.

According to various embodiments, the electronic device may control the activation of a second sensor, based on a signal received through a first sensor, which reduces power consumption of the electronic device compared to a conventional device, in which the second sensor is always activated. The electronic device may perform a predefined function in response to the signal received through the second sensor.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. The electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application specific integrated circuit (ASIC).

Various embodiments as set forth herein may be implemented as software (e.g., the program 140) including one or more instructions that are stored in a storage medium (e.g., internal memory or external memory) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. While the term “non-transitory” simply means that the storage medium is a tangible device, and does not include a signal (e.g., an electromagnetic wave), this term does not differentiate between where data is semi-permanently stored in the storage medium and where the data is temporarily stored in the storage medium.

A method according to various embodiments may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. One or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. Operations performed by the module, the program, or another component may be carried out sequentially, in parallel, repeatedly, or heuristically, or one or more of the operations may be executed in a different order or omitted, or one or more other operations may be added.

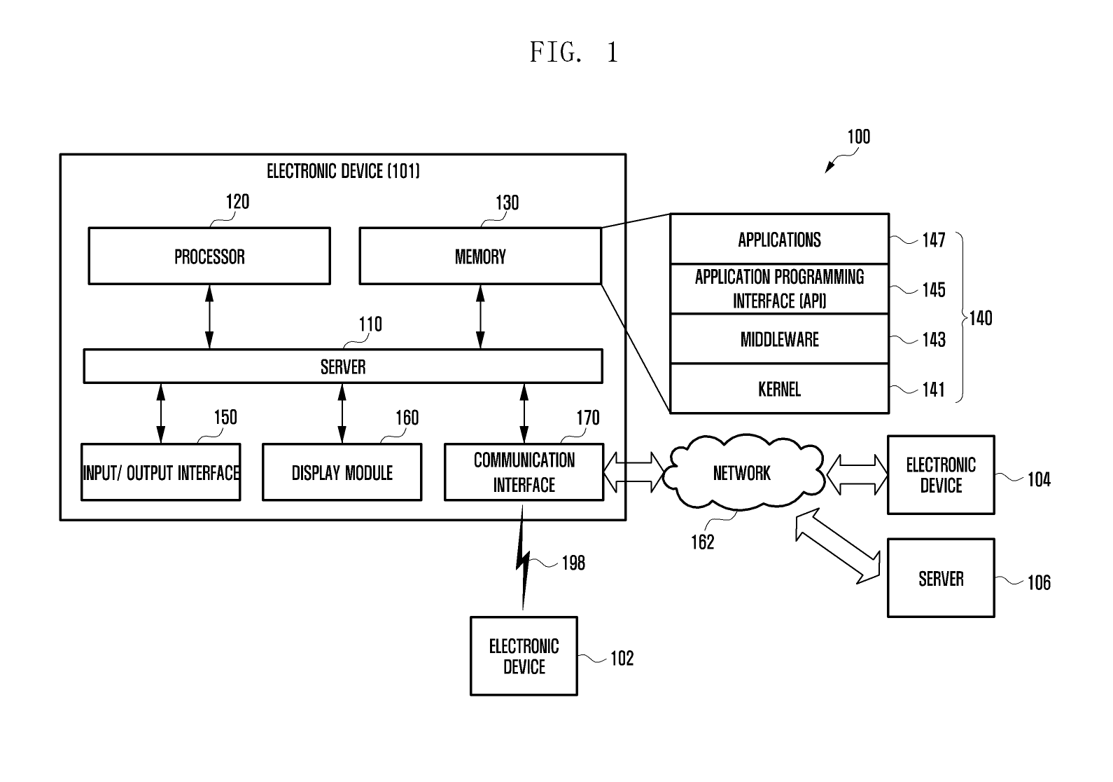

FIG. 1 is a block diagram illustrating an electronic device in a network environment 100, according to an embodiment of the present disclosure. Referring to FIG. 1, the electronic device 101 in the network environment 100 may communicate with an electronic device 102 via a first network 198 (e.g., a short-range wireless communication network), or an electronic device 104 or a server 106 via a second network 162 (e.g., a long-range wireless communication network). According to an embodiment, the electronic device 101 may communicate with the electronic device 104 via the server 106. According to an embodiment, the electronic device 101 may include a bus 110, a processor 120 (e.g., processing circuitry), a memory 130, an input/output interface 150 (e.g., input/output circuitry), a display 160, and a communication interface 170 (e.g., communication circuitry).

The bus 110 may be a circuit for interconnecting elements of the electronic device 101 and for allowing a communication, such as by transferring a control message, between the elements.

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may load a command or data received from another component (e.g., the input/output interface 150 or the communication interface 170) in volatile memory, process the command or the data stored in the volatile memory, and store resulting data in non-volatile memory. According to an embodiment, the processor 120 may include a main processor (e.g., a central processing unit (CPU) or an application processor (AP)), and an auxiliary processor (e.g., a graphics processing unit (GPU), an image signal processor (ISP), a sensor hub processor, or a communication processor (CP)) that is operable independently from, or in conjunction with, the main processor. Additionally or alternatively, the auxiliary processor may be adapted to consume less power than the main processor, or to be specific to a specified function. The auxiliary processor may be implemented as separate from, or as part of the main processor.

The auxiliary processor may control at least some of functions or states related to at least one component (e.g., the display module 160, the input/output interface 150, or the communication interface 170) among the components of the electronic device 101, instead of the main processor while the main processor is in an inactive (e.g., sleep) state, or together with the main processor while the main processor is in an active state (e.g., executing an application). According to an embodiment, the auxiliary processor (e.g., an image signal processor or a communication processor) may be implemented as part of another component (e.g., the input/output interface 150 or the communication interface 170) functionally related to the auxiliary processor.

The memory 130 may store various data used by at least one component (e.g., the processor 120 or the input/output interface 150) of the electronic device 101. The various data may include, for example, software (e.g., the program 140) and input data or output data for a command related thereto. The memory 130 may include the volatile memory or the non-volatile memory. The memory 130 may include software and/or programs 140, such as a kernel 141, middleware 143, an application programming interface (API) 145, and an application 147. Each of the programming modules described above may be configured by software, firmware, hardware, and/or combinations of at least two thereof.

The kernel 141 can control and/or manage system resources used for execution of operations and/or functions implemented in other programming modules, e.g. the middleware 143, the API 145, and/or the applications 147, and can provide an interface through which the middleware 143, the API 145, and/or the applications 147 can access and then control and/or manage an individual element of the electronic device 101.

The middleware 143 can perform a relay function which allows the API 145 and/or the applications 147 to communicate with and exchange data with the kernel 141. In relation to operation requests received from at least one of the applications 147, the middleware 143 can perform load balancing in relation to the operation requests by giving a priority for using a system resource, e.g. the bus 110, the processor 120, and/or the memory 130, of the electronic device 101 to at least one application from among the at least one of the applications 147.

The API 145 is an interface through which the applications 147 can control a function provided by the kernel 141 and/or the middleware 143, and may include at least one interface or function for file control, window control, image processing, and/or character control.

The input/output interface 150 may include various input/output circuitry that can receive a command and/or data from a user, and transfer the received command and/or data to the processor 120 and/or the memory 130 through the bus 110. The display 160 can display an image, a video, and/or data to a user.

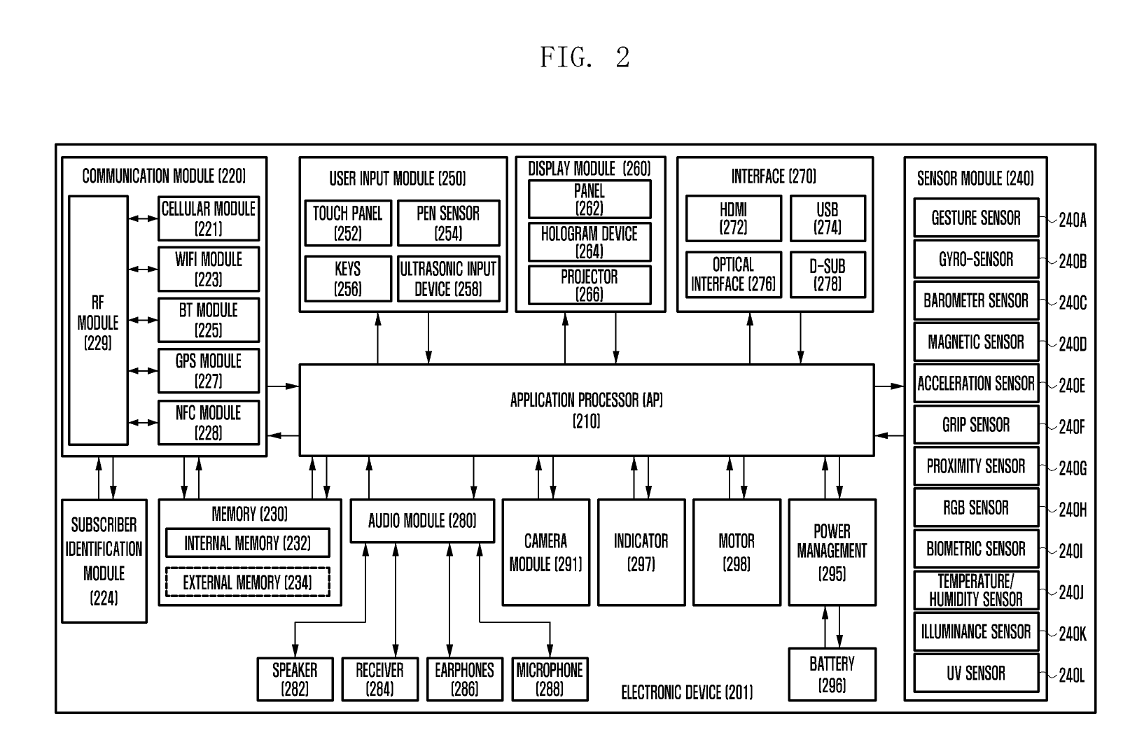

The communication interface 170 may support establishing a direct (e.g., wired) communication channel or a wireless communication channel between the electronic device 101 and the external electronic device (e.g., the electronic device 102, the electronic device 104, or the server 106) and performing communication via the established communication channel. The communication interface 170 may include one or more communication processors that are operable independently from the processor 120 (e.g., the AP) and supports a direct (e.g., wired) communication or a wireless communication. According to an embodiment, the communication interface 170 may include a wireless communication module (e.g., a cellular communication module, a short-range wireless communication module, or a global navigation satellite system (GNSS) communication module) or a wired communication module (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or Infrared Data Association (IrDA)) or the second network 162 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication interface 170 may identify and authenticate the electronic device 101 in a communication network, such as the first network 198 or the second network 162, using subscriber information (e.g., international mobile subscriber identity (IMSI)) stored in the subscriber identification module #96. FIG. 2 is a block diagram of an electronic device 201, according to an embodiment of the present disclosure. The electronic device 201 may form all or part of the electronic device 101. Referring to FIG. 2, the electronic device 201 may include at least one AP 210 (e.g., including processing circuitry), a communication module 220 (e.g., including communication circuitry), a subscriber identification module (SIM) 224, a memory 230, a sensor module 240, an user input module 250 (e.g., including input circuitry), a display 260, an interface 270 (e.g., including interface circuitry), an audio module 280, a camera module 291, a power management module 295, a battery 296, an indicator 297, and a motor 298.

The AP 210 may include various processing circuitry, and drive an operating system (OS) or applications, control a plurality of hardware or software components connected thereto, and also perform processing and operation for various data including multimedia data. The AP 210 may be formed as a system-on-chip (SoC), and may further include a GPU.

The communication module 220 may perform data communication with another electronic device connected to the electronic device 201 through the network. According to an embodiment, the communication module 220 may include various communication circuitry therein, such as, for example, and without limitation, a cellular module 221, a Wi-Fi module 223, a Bluetooth (BT) module 225, a GPS module 227, an NFC module 228, and a radio frequency (RF) module 229.

The cellular module 221 may offer a voice call, a video call, a message service, or an Internet service through a communication network, such as long term evolution (LTE), LTE-advanced (LTE-A), code division multiple access (CDMA), wideband CDMA (WCDMA), universal mobile telecommunications system (UMTS), WiBro, or global system for mobile communication (GSM). Additionally, the cellular module 221 may perform identification and authentication of the electronic device in the communication network, using the SIM 224. According to an embodiment, the cellular module 221 may perform at least part of functions the AP 210 can provide, such as a multimedia control function.

According to an embodiment, the cellular module 221 may include a CP, and may be formed of an SoC, for example. Although some elements such as the cellular module 221, the CP, the memory 230, or the power management module 295 are illustrated as separate and distinct elements from the AP 210, the AP 210 may be formed to have at least part of the above elements.

According to an embodiment, the AP 210 or the cellular module 221 may load commands or data, received from a nonvolatile memory connected thereto or from at least one of the other elements, into a volatile memory to process them. Additionally, the AP 210 or the cellular module 221 may store data, received from or created at one or more of the other elements, in the nonvolatile memory.

Each of the Wi-Fi module 223, the BT module 225, the GPS module 227, and the NFC module 228 may include a processor for processing data transceived therethrough. According to an embodiment, the cellular module 221, the Wi-Fi module 223, the BT module 225, the GPS module 227, and the NFC module 228 may be contained in a single integrated circuit (IC) chip or a single IC package, e.g., may be formed as a single SoC.

The RF module 229 may transceive RF signals or any other electric signals, and may include a transceiver, a power amp module (PAM), a frequency filter, or a low noise amplifier (LNA). The RF module 229 may further include any component, e.g., a wire or a conductor, for transmission of electromagnetic waves in a free air space. According to an embodiment, the cellular module 221, the Wi-Fi module 223, the BT module 225, the GPS module 227 and the NFC module 228 share the RF module 229, may transceive RF signals through a separate RF module.

The SIM 224 may be a specific card formed of SIM and may be inserted into a slot formed at a certain location of the electronic device. The SIM 224 may contain therein an integrated circuit card identifier (ICCID) ( ) or an IMSI identity.

The memory 230 may include an internal memory 232 and/or an external memory 234. The internal memory 232 may include at least one of a volatile memory (e.g., dynamic random access memory (DRAM), static RAM (SRAM), synchronous DRAM (SDRAM), or a nonvolatile memory (e.g., one time programmable read-only memory (OTPROM), programmable ROM (PROM), erasable and programmable ROM (EPROM), electrically erasable and programmable ROM (EEPROM), mask ROM, flash ROM, NAND flash memory, and NOR flash memory).

According to an embodiment of the present disclosure, the internal memory 232 may have the form of a solid state drive (SSD). The external memory 234 may include a flash drive, e.g., compact flash (CF), secure digital (SD), micro secure digital (micro-SD), mini secure digital (mini-SD), extreme digital (xD), or memory stick, and may be functionally connected to the electronic device 201 through various interfaces. The electronic device 201 may further include a storage device or medium such as a hard drive.

The sensor module 240 may measure physical quantity or sense an operating status of the electronic device 201, and then convert measured or sensed information into electrical signals. The sensor module 240 may include at least one of a gesture sensor 240A, a gyro sensor 240B, a pressure sensor 240C (e.g., barometer), a magnetic sensor 240D, an acceleration sensor 240E, a grip sensor 240F, a proximity sensor 240G, a color sensor 240H (e.g., a red, green, blue (RGB) sensor), a biometric sensor 240I, a temperature-humidity sensor 240J, an illumination sensor 240K, and a ultraviolet (UV) sensor 240L. Additionally or alternatively, the sensor module 240 may include an E-nose sensor, an electromyography (EMG) sensor, an electroencephalogram (EEG) sensor, an electrocardiogram (ECG) sensor, an infrared (IR) sensor, an iris scan sensor, or a finger scan sensor. The sensor module 240 may include a control circuit for controlling one or more sensors equipped therein.

The user input module 250 may include various input circuitry, such as, for example, and without limitation, a touch panel 252, a digital pen sensor 254, a key 256, or an ultrasonic input device 258. The touch panel 252 may recognize a touch input in a capacitive, resistive, infrared, or ultrasonic type manner. The touch panel 252 may further include a control circuit. In the case of a capacitive type, a physical contact or proximity may be recognized. The touch panel 252 may further include a tactile layer that offers a tactile feedback to a user.

The digital pen sensor 254 may be formed in the same or similar manner as receiving a touch input or by using a separate recognition sheet. The key 256 may include a physical button, an optical key, or a keypad. The ultrasonic input device 258 is capable of identifying data by sensing sound waves with a microphone (MIC) 288 in the electronic device 201 through an input tool that generates ultrasonic signals, thus allowing wireless recognition. According to an embodiment, the electronic device 201 may receive a user input from another external device connected thereto through the communication module 220.

The display 260 may include a panel 262, a hologram device 264, or a projector 266. The panel 262 may be a liquid crystal display (LCD), or an active matrix organic light emitting diode (AM-OLED), may have a flexible, transparent, or wearable form, and may be formed of a single module with the touch panel 252. The hologram device 264 may project a stereoscopic image in the air using interference of light. The projector 266 may project an image onto a screen, which may be located at the inside or outside of the electronic device 201. According to an embodiment, the display 260 may further include a control circuit for controlling the panel 262, the hologram device 264, and the projector 266.

The interface 270 may include various interface circuitry, such as, for example, and without limitation, a high-definition multimedia interface (HDMI) 272, a universal serial bus (USB) 274, an optical interface 276, and a d-subminiature (d-sub) 278, and may be contained in the communication interface 170. Additionally or alternatively, the communication interface 270 may include a mobile high-definition link (MHL) interface, an SD card/multi-media card (MMC) interface, or an IrDA interface.

The audio module 280 may perform a conversion between sounds and electric signals. At least part of the audio module 280 may be contained in the input/output interface 150. The audio module 280 may process sound information input or output through a speaker 282, a receiver 284, an earphone 286, or the MIC 288.

The camera module 291 is capable of obtaining still images and moving images, and may include at least one image sensor (e.g., a front sensor or a rear sensor), a lens, an ISP, or a flash (e.g., a light emitting diode (LED) or xenon lamp).

The power management module 295 may manage the electric power of the electronic device 201 and may include a power management integrated circuit (PMIC), a charger IC, or a battery gauge.

The PMIC may be formed as an IC chip or SoC. Charging may be performed in a wired or wireless manner. The charger IC may charge a battery 296, and prevent overvoltage or overcurrent from a charger. According to an embodiment, the charger IC may have a charger IC used for at least one of wired and wireless charging types. A wireless charging type may include a magnetic resonance type, a magnetic induction type, or an electromagnetic type. Any additional circuit for a wireless charging may be further used, such as a coil loop, a resonance circuit, or a rectifier.

The battery gauge may measure the residual amount of the battery 296 and a voltage, current, or temperature in a charging process. The battery 296 may store or create electric power therein and supply electric power to the electronic device 201. The battery 296 may be a rechargeable or solar battery.

The indicator 297 may show a current status (e.g., a booting, message, or recharging status) of part or all of the electronic device 201. The motor 298 may convert an electric signal into a mechanical vibration. The electronic device 201 may include a specific processor, such as GPU, for supporting a mobile TV. This processor may process media data that comply with the standards of digital multimedia broadcasting (DMB), digital video broadcasting (DVB), or media flow™.

Each of the above-discussed elements of the electronic device disclosed herein may be formed of one or more components, and may have various names according to the type of the electronic device. The electronic device disclosed herein may be formed of at least one of the above-discussed elements without some elements or with additional elements. Some of the elements may be integrated into a single component that still performs the same functions as those of such elements before being integrated.

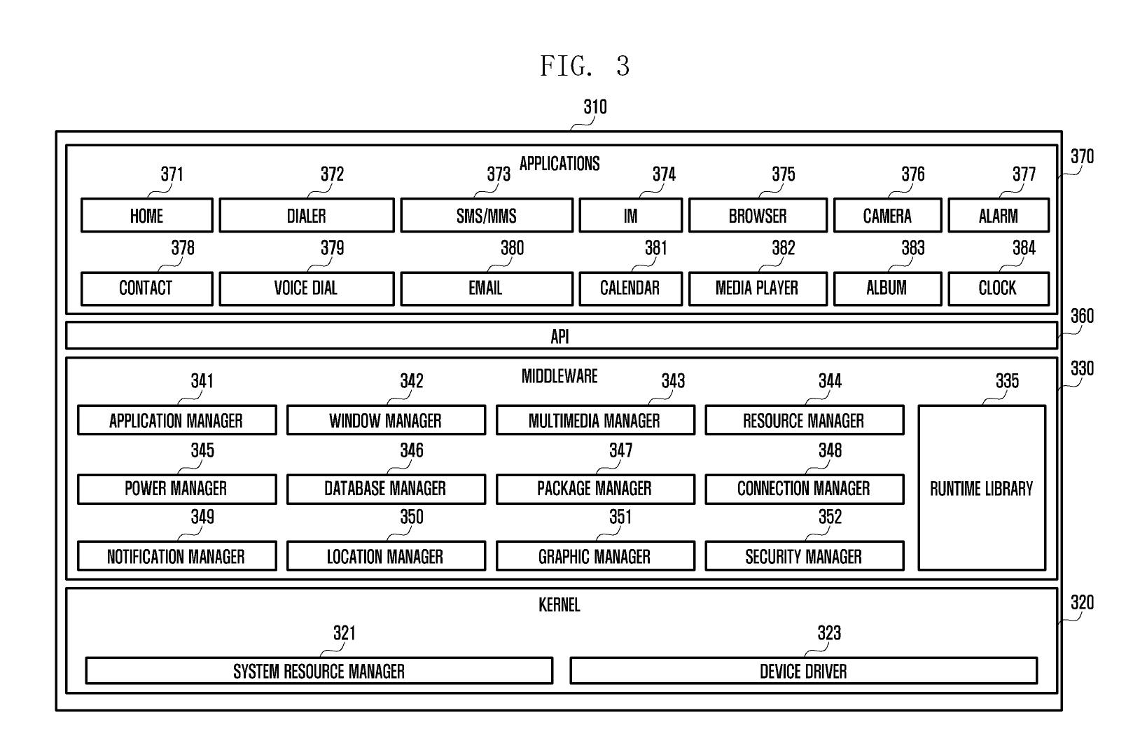

FIG. 3 is a block diagram 310 illustrating the program module 370, according to an embodiment of the present disclosure. According to an embodiment, the program module 370 may include an OS to control one or more resources of the electronic device 101, kernel 320, middleware 330, API 360, or an application 370 executable in the OS. The OS may include, for example, Android™, iOS™, Windows™, Symbian™, Tizen™, or Bada™. At least part of the program module 370, for example, may be pre-loaded on the electronic device 101 during manufacture, or may be downloaded from or updated by an external electronic device (e.g., the electronic device 102 or 104, or the server 106) during use by a user.

The OS may control management (e.g., allocating or deallocation) of one or more system resources (e.g., process, memory, or power source) of the electronic device 101. The OS, additionally or alternatively, may include one or more driver programs to drive other hardware devices of the electronic device 101, for example, the input/output interface 150, the display 160, and the communication interface 170.

At least a part of the programming module 310 may be implemented in software, firmware, hardware, or a combination of two or more thereof. The kernel 320 may include a system resource manager 321 and/or a device driver 323. The system resource manager 321 may include a process manager, a memory manager, and a file system manager. The system resource manager 321 may perform the control, allocation, or recovery of system resources. The device driver 323 may include a display driver, a camera driver, a Bluetooth driver, a shared memory driver, a USB driver, a keypad driver, a Wi-Fi driver, and/or an audio driver, and may further include an inter-process communication (IPC) driver.

The middleware 330 may provide various functions to the application 370 such that a function or information provided from one or more resources of the electronic device 101 may be used by the application 370. The middleware 330 may include, for example, a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager.

The runtime library 335 may include a library module used by a complier, in order to add a new function by using a programming language during the execution of the applications 370, and may perform functions which are related to input and output, the management of a memory, or an arithmetic function.

The application manager 341 may manage a life cycle of at least one of the applications 370. The window manager 342 may manage GUI resources used on the screen. The multimedia manager 343 may detect a format used to reproduce various media files and may encode or decode a media file through a codec appropriate for the relevant format. The resource manager 344 may manage resources, such as a source code, a memory, or a storage space, of at least one of the applications 370.

The power manager 345 may operate together with a basic input/output system (BIOS), may manage a battery or power, and may provide power information used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connection or a direct connection between the electronic device 101 and the external electronic device. The notification manager 349 may provide a function to notify a user of an occurrence of a specified event (e.g., an incoming call, message, or alert). The location manager 350 may manage location information of the electronic device. The graphics manager 351 may manage graphic effects, which are to be provided to the user, and/or a user interface related to the graphic effects. The security manager 352 may provide various security functions used for system security and user authentication. According to an embodiment, when the electronic device has a telephone function, the middleware 330 may further include a telephony manager for managing a voice and/or video telephony call function of the electronic device.

The middleware 330 may generate and use a new middleware module through various functional combinations of the above-described internal element modules, may provide modules specialized according to types of the OS in order to provide differentiated functions, and may dynamically delete some of the existing elements, or may add new elements. Accordingly, the middleware 330 may omit some of the elements described in the embodiments of the present disclosure, may further include other elements, or may replace some of the elements with elements, each of which performing a similar function and having a different name.

The API 360 is a set of API programming functions, and may be provided with a different configuration according to an OS. In the case of Android or iOS, for example, one API set may be provided to each platform. In the case of Tizen, two or more API sets may be provided to each platform.

The applications 370 may include a preloaded application and/or a third party application, and may include a home 371 application, dialer 372 application, a short message service (SMS)/multimedia messaging service (MMS) 373 application, instant message (IM) 374 application, browser 375 application, camera 376 application, alarm 377 application, contact 378 application, voice dial 379 application, electronic mail (e-mail) 380 application, calendar 381 application, media player 382 application, album 383 application, and clock 384 application, and any other suitable and/or similar application.

At least a part of the programming module 310 may be implemented by instructions stored in a non-transitory computer-readable storage medium. When the instructions are executed by one or more processors, the one or more processors may perform functions corresponding to the instructions. The non-transitory computer-readable storage medium may be the memory 220. At least a part of the programming module 310 may be executed by the one or more processors 210, and may include a module, a program, a routine, a set of instructions, and/or a process for performing one or more functions.

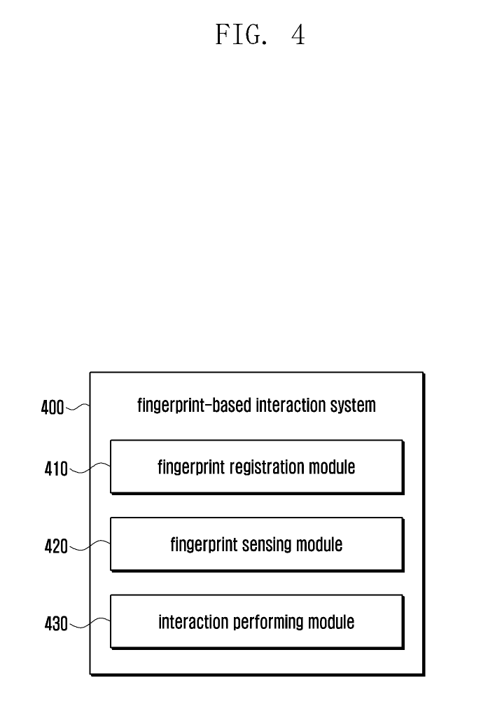

FIG. 4 is a diagram illustrating a fingerprint-based interaction system, according to various embodiments.

Referring to FIG. 4, a fingerprint-based interaction system 400 may include a fingerprint registration module 410, a fingerprint sensing module 420, and an interaction performing module 430.

According to various embodiments, the electronic device 101 may perform various interactions corresponding to an input fingerprint through the fingerprint-based interaction system 400. For example, the electronic device 101 may perform interactions, such as location movement, viewpoint adjustment, angle adjustment, scroll, fast scroll, detailed view, and tap switching, based on a sensed fingerprint.

The electronic device 101 may register a user's fingerprint through the fingerprint registration module 410. The fingerprint registration module 410 may be electrically or functionally connected to a fingerprint sensor or a display 260 to acquire information on the user's fingerprint.

The electronic device 101 may perform stereoscopic formation (or shaping) of the fingerprint based on information on the fingerprint through the fingerprint registration module 410, and may store feature information (e.g., stereoscopic information or shape information) on the fingerprint. The information on the fingerprint may include minutiae of the input fingerprint. For example, the minutiae relate to a primary feature made by a ridge and a valley of the fingerprint, and may include a ridge end at which the ridge of the fingerprint is discontinued, a bifurcation of the fingerprint, a core of the fingerprint, and a delta of the fingerprint. The fingerprint registration module 410 may receive the fingerprint input once or plural times from a user for stereoscopic formation or shaping of the fingerprint.

The electronic device 101 may sense the user's fingerprint placed on the fingerprint sensor or the display 260 through the fingerprint sensing module 420. The fingerprint sensing module 420 may be electrically or functionally connected to the fingerprint sensor or the display 260 to acquire information on the input fingerprint.

According to various embodiments, the electronic device 101 may identify to what area (or portion) of a pre-stored fingerprint the sensed (or input) fingerprint corresponds based on the feature information of the pre-stored fingerprint through the fingerprint sensing module 420. If a user inputs his/her fingerprint with the fingertip kept upright, the electronic device 101 may identify that a fingerprint corresponding to the front end portion of the feature information of the pre-stored fingerprint has been input.

According to various embodiments, the electronic device 101 may sense rolling of the fingerprint through the fingerprint sensing module 420. For example, the fingerprint sensing module 420 may identify that movement of the input fingerprint (e.g., movement of the ridge) from first minutiae to second minutiae have occurred based on the feature information of the pre-registered fingerprint. For example, the fingerprint sensing module 420 may acquire information on the continuous movement (e.g., direction of inclination and degree of inclination) of a touched contact (e.g., contact between the fingerprint sensor and the finger).

In sensing the rolling of the fingerprint through the fingerprint sensing module 420, the electronic device 101 may determine the degree of rolling based on the contact during an initial touch. Further, in sensing the rolling of the fingerprint through the fingerprint sensing module 420, the electronic device 101 may determine the degree of rolling based on the core of the pre-registered fingerprint. On the other hand, in case of sensing the rolling, the fingerprint sensing module 420 may set up the existence of the contact as a trigger, or, if the contact area satisfies a predetermined width, space, location, etc., the fingerprint sensing module 420 may set up such a condition as a trigger.

The electronic device 101 may perform various interactions based on the area in which the sensed fingerprint belongs to the feature information of the pre-stored fingerprint through the interaction performing module 430. For example, the interaction performing module 430 may perform interactions, such as location movement, viewpoint adjustment, angle adjustment, scroll, fast scroll, detailed view, and tap switching, based on the sensed fingerprint.

The electronic device 101 may perform various interactions based on the rolling of the fingerprint through the interaction performing module 430. For example, the interaction performing module 430 may perform the interactions, such as the location movement, viewpoint adjustment, angle adjustment, scroll, fast scroll, detailed view, and tap switching, based on the rolling of the sensed fingerprint (e.g., rotation of the finger).

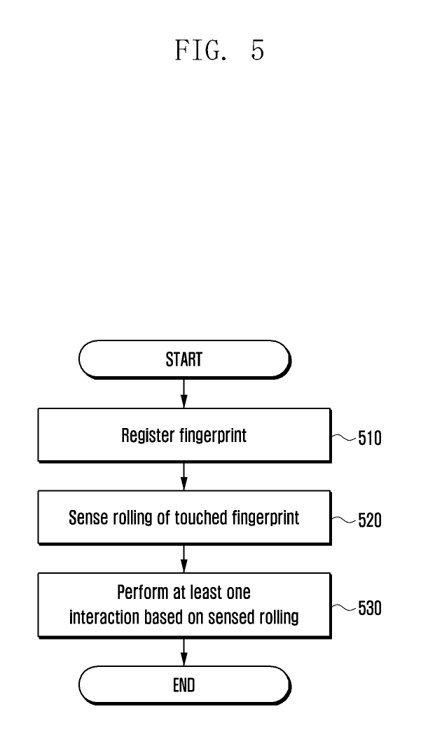

FIG. 5 is a flowchart illustrating a method for performing at least one interaction by sensing rolling of a fingerprint on an electronic device, according to various embodiments.

Referring to FIG. 5 at step 510, the electronic device 101 may register a user's fingerprint. The electronic device 101 may be electrically or functionally connected to a fingerprint sensor or a display 260 to acquire information on the user's fingerprint.

According to various embodiments, the electronic device 101 may perform stereoscopic formation (or shaping) of the fingerprint based on information on the fingerprint, and may store feature information (e.g., stereoscopic information or shape information) on the fingerprint. The information on the fingerprint may include minutiae of the input fingerprint. For example, the minutiae relate to a primary feature made by a ridge and a valley of the fingerprint, and may include a ridge end at which the ridge of the fingerprint is discontinued, a bifurcation of the fingerprint, a core of the fingerprint, and a delta of the fingerprint. The electronic device 101 may receive the fingerprint input once or a plurality of times from a user for the stereoscopic formation of the fingerprint.

At step 520, the electronic device 101 may sense a touched fingerprint or rolling of the touched fingerprint.

The electronic device 101 may sense the user's fingerprint put on the fingerprint sensor or the display 260. The electronic device 101 may be electrically or functionally connected to the fingerprint sensor or the display 260 to acquire information on the input fingerprint.

According to various embodiments, the electronic device 101 may identify to what area (or portion) of a pre-stored fingerprint the sensed (or input) fingerprint corresponds based on the feature information of the pre-stored fingerprint. If a user inputs his/her fingerprint with the fingertip kept upright, the electronic device 101 may identify that a fingerprint corresponding to the front end portion of the feature information of the pre-stored fingerprint has been input.

According to various embodiments, the electronic device 101 may sense rolling of the fingerprint. The electronic device 101 may identify that movement of the input fingerprint (e.g., movement of the ridge) from a first minutiae to a second minutiae have occurred based on the feature information of the pre-registered fingerprint. For example, the electronic device 101 may acquire information on the continuous movement (e.g., direction of inclination and degree of inclination) of a touched contact (e.g., contact between the fingerprint sensor and the finger).

According to various embodiments, in sensing the rolling of the fingerprint, the electronic device 101 may determine the degree of rolling based on the contact during an initial touch. Further, in sensing the rolling of the fingerprint, the electronic device 101 may determine the degree of rolling based on the core of the pre-registered fingerprint. On the other hand, in case of sensing the rolling, the electronic device 101 may set up the existence of the contact as a trigger, or, if the contact area satisfies a predetermined width, space, location, etc., the electronic device 101 may set up such a condition as a trigger.

At step 530, the electronic device 101 may perform at least one interaction based on the touched fingerprint or the rolling of the touched fingerprint.

According to various embodiments, the electronic device 101 may perform various interactions based on the area in which the sensed fingerprint belongs to the feature information of the pre-stored fingerprint. At step 520, the electronic device 101 may perform interactions, such as location movement, viewpoint adjustment, angle adjustment, scroll, fast scroll, detailed view, and tap switching, based on the sensed fingerprint. That is, if the fingerprint does not roll, the electronic device 101 may determine to what area of the feature information of the pre-stored fingerprint the fingerprint corresponding to the sensed contact belongs, and may perform at least one interaction based on the determination.

According to various embodiments, the electronic device 101 may perform various interactions based on the rolling of the fingerprint. For example, the electronic device 101 may perform the interactions, such as the location movement, viewpoint adjustment, angle adjustment, scroll, fast scroll, detailed view, and tap switching, based on the rolling of the sensed fingerprint (e.g., rotation of the finger).

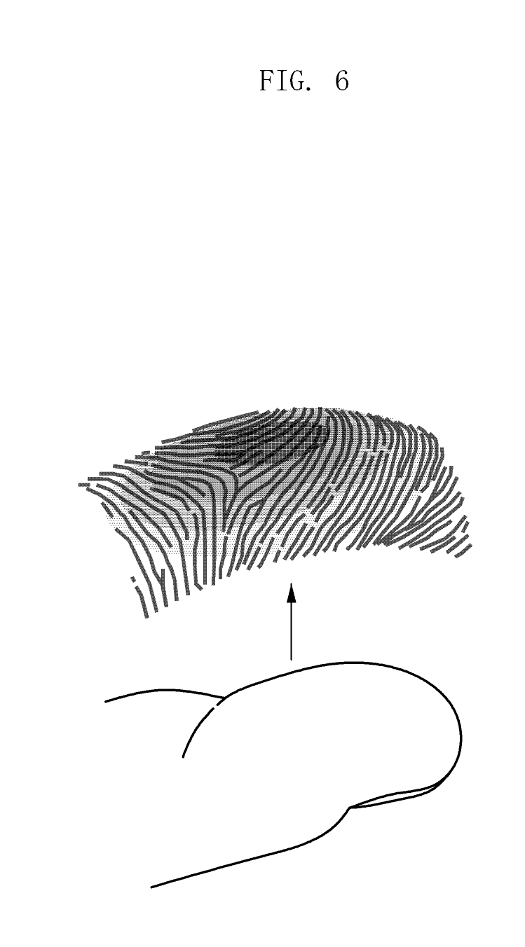

FIG. 6 is a diagram illustrating that an electronic device can perform stereoscopic formation of a fingerprint, according to various embodiments.

Referring to FIG. 6 the electronic device 101 may acquire a user's fingerprint information at various angles, and based on this, it may perform stereoscopic formation of the user's fingerprint. The electronic device 101 may store feature information on the user's fingerprint, and based on this, it may identify to what area of the whole fingerprint the fingerprint at the touched contact belongs.

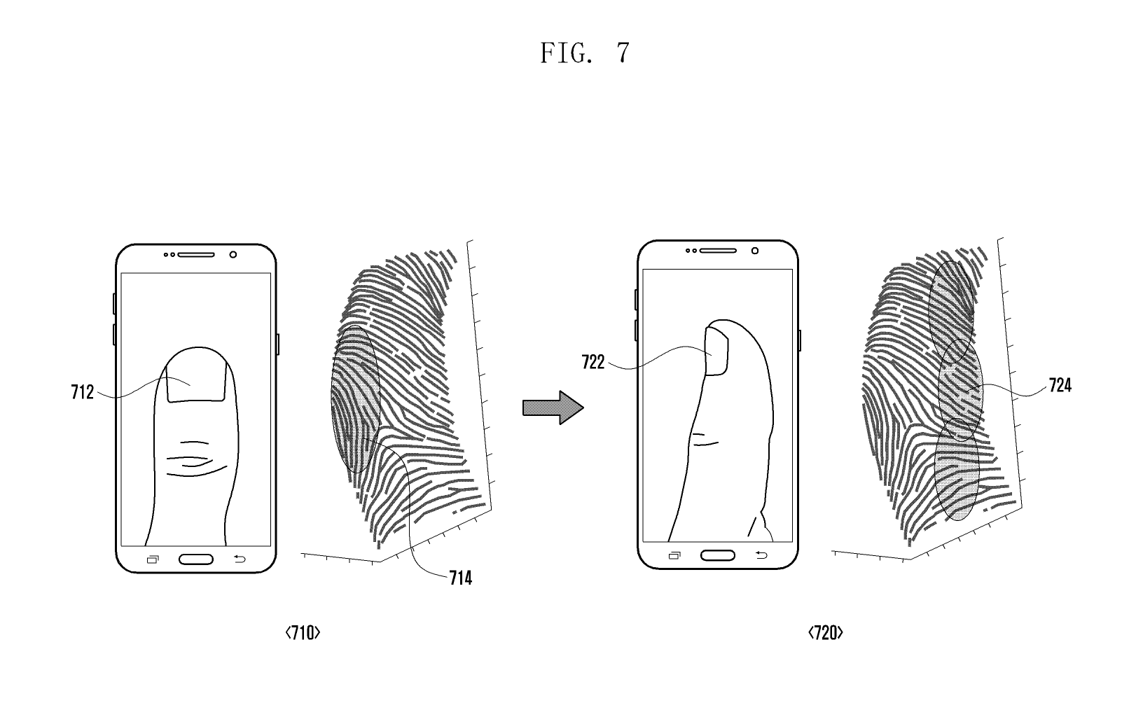

FIG. 7 is a diagram illustrating that an electronic device can identify to what portion in a pre-registered fingerprint a sensed fingerprint corresponds based on a state where the fingerprint is put, according to various embodiments.

Referring to 710 of FIG. 7 it may be assumed that a front portion of a user's finger 712 comes in contact with a fingerprint sensor of an electronic device 101. The electronic device 101 may sense an actually touched contact 714 based on feature information of a fingerprint pre-stored in the electronic device 101.

Referring to 720 of FIG. 7 it may be assumed that a side portion of a user's finger 722 comes in contact with the fingerprint sensor of the electronic device 101. The electronic device 101 may sense an actually touched contact 724 based on the feature information of the fingerprint pre-stored in the electronic device 101.

Through this, the electronic device 101 may identify an absolute location of an area where the user's fingerprint is sensed among the whole area of the fingerprint. Further, the electronic device 101 may identify a relative location of the area where the user's fingerprint is sensed based on a specific location or point among the whole area of the fingerprint.

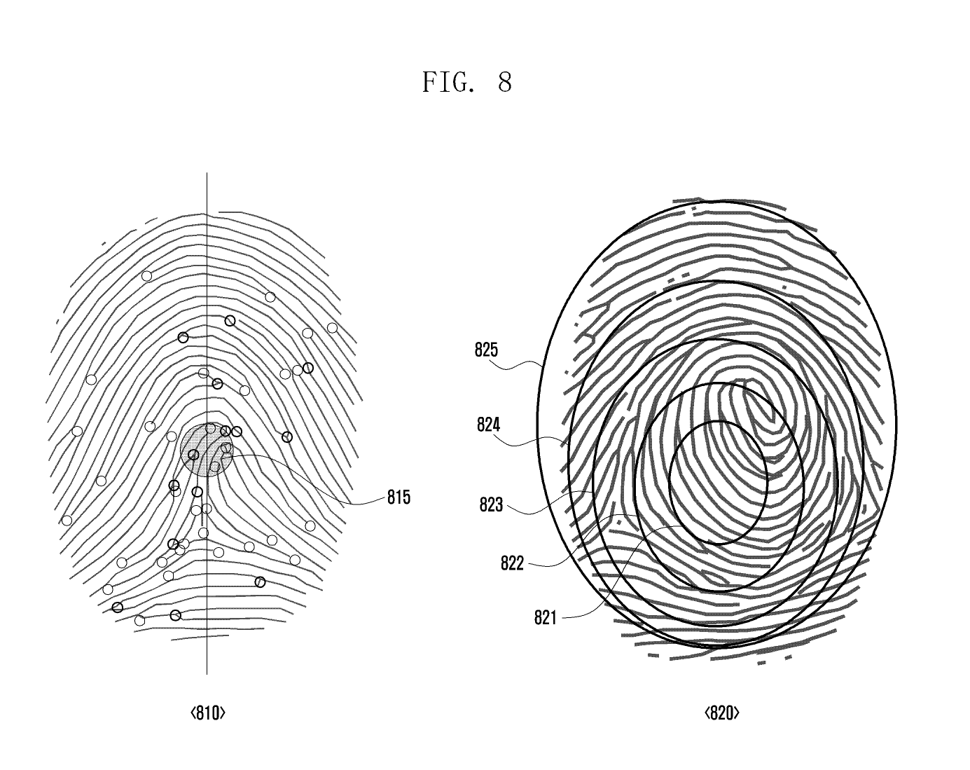

FIG. 8 is a diagram illustrating a method in which an electronic device configures a core of a fingerprint and a method in which the electronic device identifies the degree of inclination of a sensed fingerprint as a part of the sensed fingerprint becomes apart based on the core, according to various embodiments.

Referring to 810 of FIG. 8, the electronic device 101 may store feature information of a fingerprint based on the input fingerprint, and may acquire a core 815 from the feature information. The electronic device 101 may designate a portion having the largest curvature of the ridge of the fingerprint as the core based on the feature information of the fingerprint. Here, the core may be changed in accordance with the user's setup or manufacturer's setup, and a point at which it is easy to sense rolling of the fingerprint based on the input fingerprint may be set up as the core. A touched area may differ depending on a user's touch habit, and the electronic device 101 may set up the center of the touched area as the core.

Referring to 820 of FIG. 8, the electronic device 101 may store the feature information of the fingerprint based on the input fingerprint, and may divide the feature information into specific regions 821 to 825. The electronic device 101 may identify the direction of rolling of the user's fingerprint and the degree of inclination based on the feature information divided into the specific regions 821 to 825. The electronic device 101 may identify an angle difference between the regions 821 and 825 as 90°. Here, the angle difference according to the region difference is not limited to the above-described embodiment, the degree of sensitivity with respect to the angle change may differ in accordance with the user's setup or manufacturer's setup.

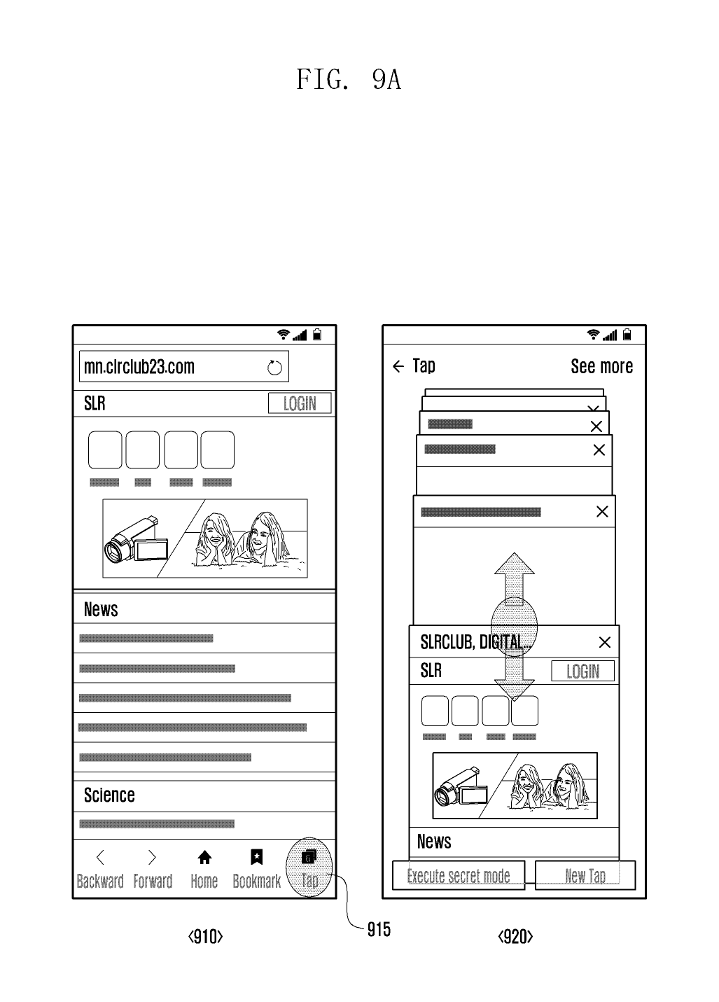

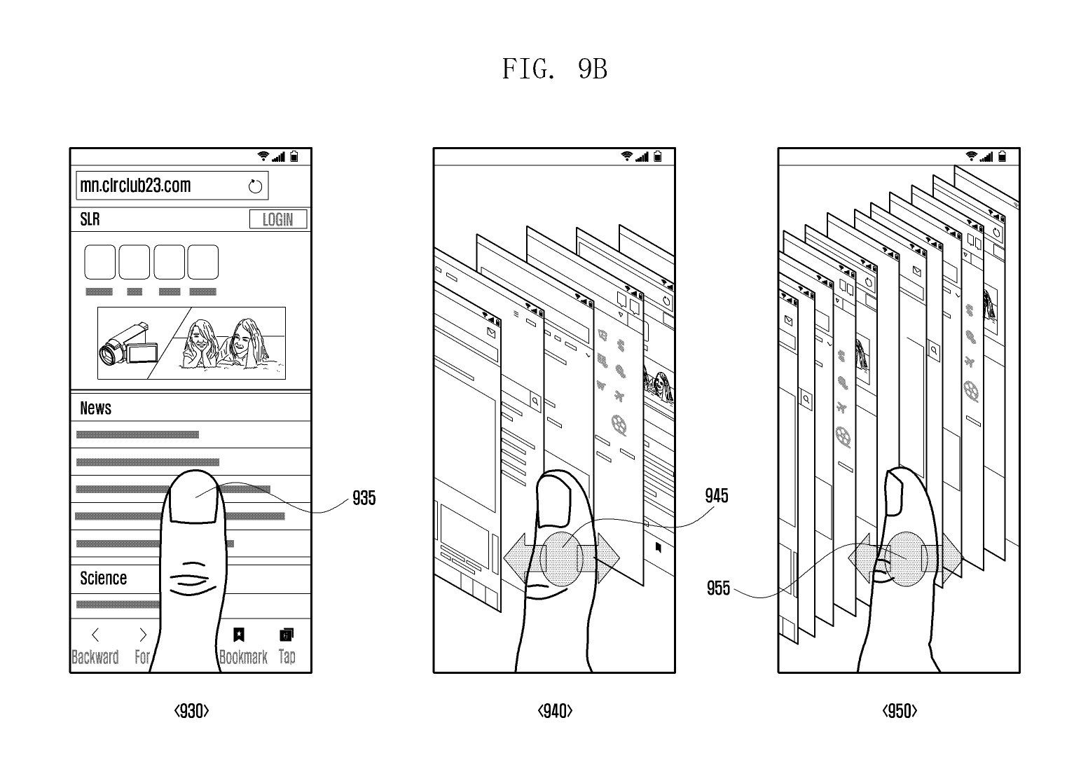

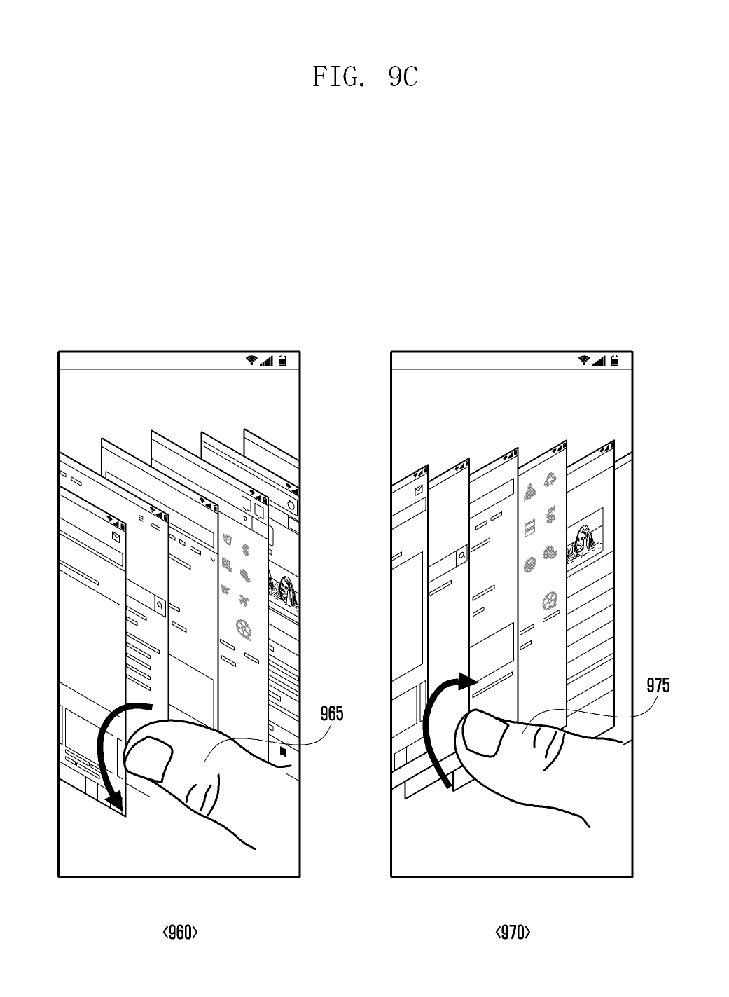

FIG. 9A is a diagram illustrating a method in which a web application of an electronic device displays at least one window through a tab function, according to various embodiments.

Referring to FIG. 9A, the electronic device 101 may execute a web application. The web application may store and display information on the previously activated window in addition to the currently activated window. Referring to 910 of FIG. 9A, the electronic device 101 may receive an input of pressing a tab button 915 from a user. Referring to 920 of FIG. 9A, the electronic device 101 may display at least one previously activated window through the web application corresponding to the reception of the input of pressing the tab button 915.

FIGS. 9B and 9C are diagrams illustrating a method in which a web application of an electronic device displays at least one window through an input of a fingerprint, according to various embodiments.

Referring to FIGS. 9B and 9C, the electronic device 101 may display the at least one pre-activated window through the web application even if the tab button is not pressed as illustrated in FIG. 9A.

Referring to 930 of FIG. 9B, the electronic device 101 may identify that a user's finger 935 is located on a display 260, and based on this, the electronic device 101 may sense the user's fingerprint. The electronic device 101 may identify that a front portion of the user's finger 935 comes in contact with the display 260, and may identify that a touched contact is an area corresponding to the core of the fingerprint.

Referring to 940 and 950 of FIG. 9B, the electronic device 101 may identify that a side portion of the user's finger 945 or 955 comes in contact with the display 260, and may identify that the touched contact is actually an area that is separate from the core of the fingerprint which corresponds to the edge. The electronic device 101 may identify that the degree of inclination of the finger corresponding to 955 is greater than the degree of inclination of the finger corresponding to 945.

According to various embodiments, if the electronic device 101 determines that the contact touched by the user's finger 945 or 955 becomes apart from the core of the fingerprint, it may perform a tab function. That is, as illustrated in FIG. 9A, the tab function may be performed simply through rolling (e.g., inclination toward the side portion) of the fingerprint without the necessity of moving the location of the finger to press the tab button 915 during scrolling. The electronic device 101 may adjust the number of windows to be displayed during performing of the tab function based on the degree of inclination of the user's finger. Since the inclination of the finger corresponding to 955 is steeper than the inclination of the finger corresponding to 945, the number of windows displayed on 950 may be larger than the number of windows displayed on 940. If the user touches the display with the side portion of the fingerprint without using the rolling of the fingerprint, the electronic device 101 may directly perform the tab function.

Referring to 960 and 970 of FIG. 9C, the electronic device 101 may perform the tab function according to the directivity in the feature information of the fingerprint in the area touched by the finger. For example, the electronic device 101 may identify that the directivity of the finger corresponding to 965 is opposite to the directivity of the finger corresponding to 975, and corresponding to this, it may adjust the direction of the window arrangement so that the direction of the window arrangement indicated in 960 is opposite to the direction of the window arrangement indicated in 970.

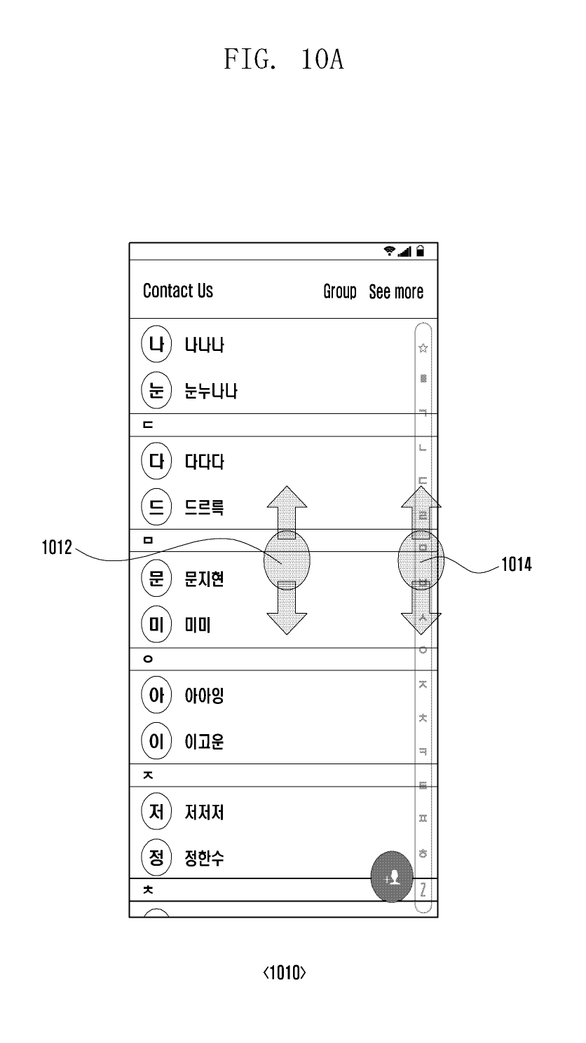

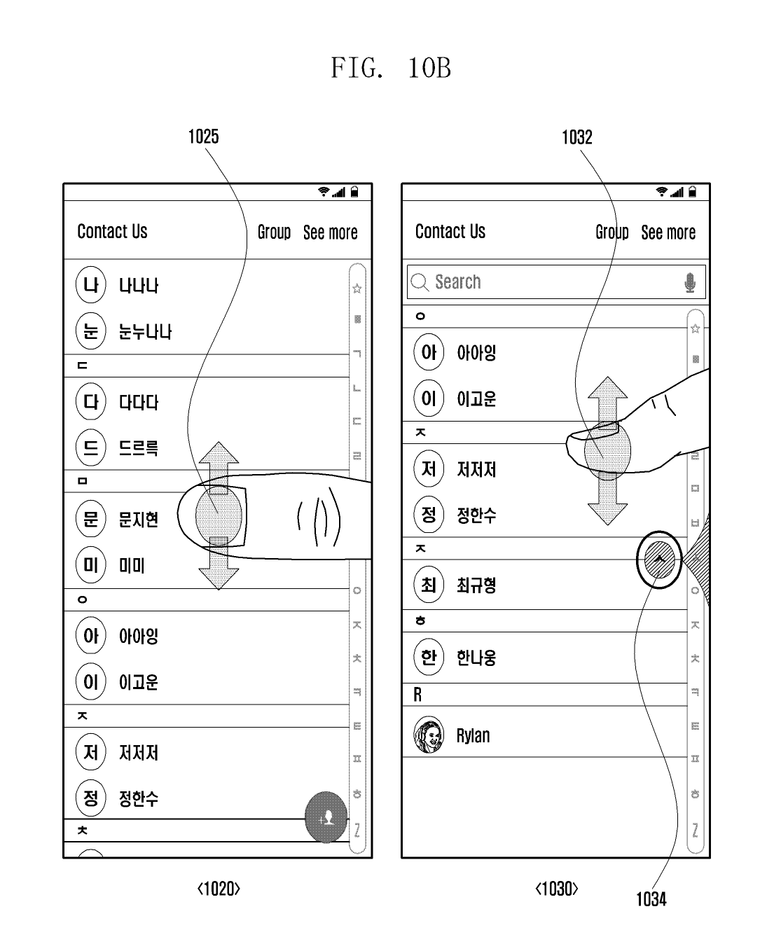

FIG. 10A is a diagram illustrating a method in which a contact us application of an electronic device searches for contact information through a drag input and a tap input, according to various embodiments.

Referring to 1010 of FIG. 10A, the electronic device may execute a contact us application. The electronic device 101 may receive a drag input 1012 for an area excluding the index from the contact us application, and corresponding to this, it may successively move and display contact us items.

According to various embodiments, the electronic device 101 may receive a tab input or a drag input 1014 for the index area from the contact us application. Corresponding to this, the electronic device 101 may select and move the index to the area corresponding to the selected index at a time to display the index.

FIG. 10B is a diagram illustrating a method in which a contact us application of an electronic device searches for contact information through an input of a fingerprint, according to various embodiments.

Referring to items 1020 and 1030 of FIG. 10B, the electronic device 101 may execute a contact us application. The electronic device 101 may receive a drag input 1025 in a state where the front portion of the finger comes in contact with the display 260.

According to various embodiments, the electronic device 101 may sense rolling 1032 of the finger in a place other than the index area through the contact us application. Corresponding to this, the electronic device 101 may select the index 1034, and may discontinuously move the contact us item (e.g., move the contact us item to the area corresponding to the selected index at a time) to display the item. The electronic device 101 may minutely divide the feature information of the pre-stored fingerprint, and may store the divided feature information together with the index information. Corresponding to this, the touched contact is changed in accordance with the rolling of the fingerprint, and thus it becomes possible to move the index to the area corresponding to the selected index at a time and to display the index. Through this, even if the index area is not directly selected, the contact us can be searched more simply through the feature information of the fingerprint.

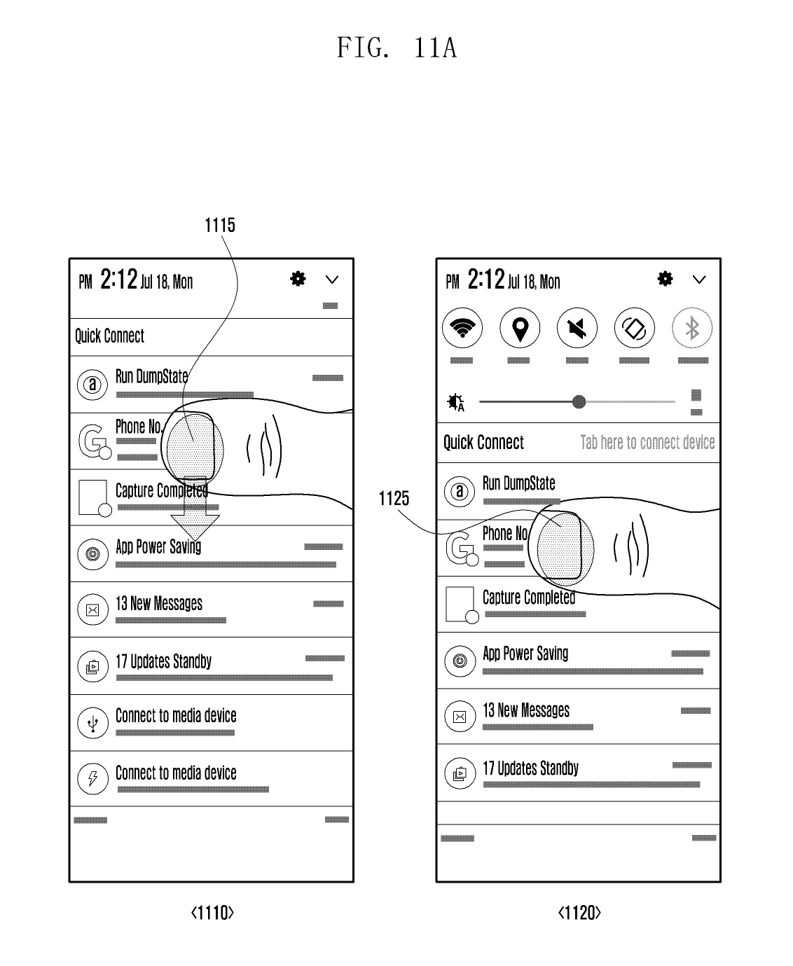

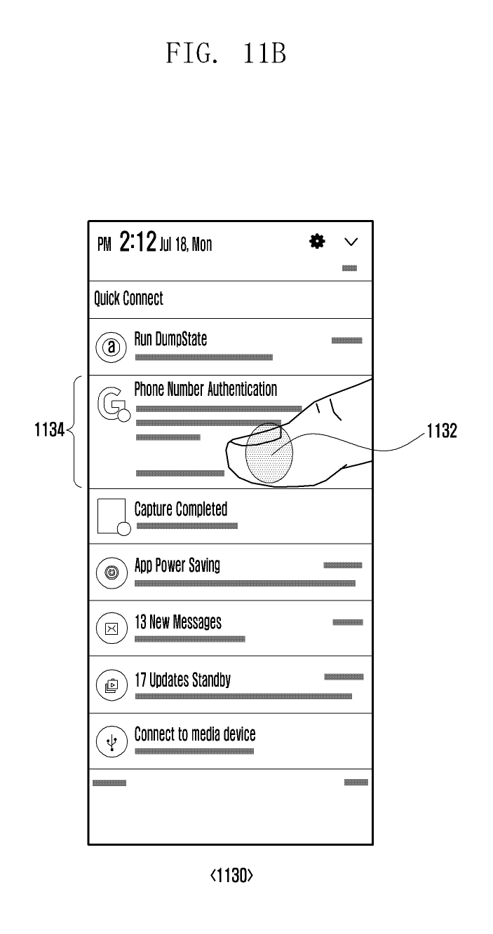

FIG. 11A is a diagram illustrating a method in which an electronic device identifies a notification list through a drag input, according to various embodiments.

Referring to 1110 and 1120 of FIG. 11A, the electronic device may display a notification list. The electronic device 101 may receive a drag input for an area displayed in the notification list (e.g., movement of a finger on the display from a location corresponding to 1115 to a location corresponding to 1125), and corresponding to this, it may scroll the notification displayed in the notification list.

The electronic device 101 may not display the whole contents of the notification in the notification list due to the long contents of the notification and a limited space of the notification items. In order to identify the whole contents of a specific notification, a user may identify the whole contents of the specific notification by executing the corresponding application through selection of the item corresponding to the specific notification.

FIG. 11B is a diagram illustrating a method in which an electronic device identifies in detail at least one notification in a notification list through an input of a fingerprint, according to various embodiments.

Referring to 1130 of FIG. 11B, the electronic device 101 may sense rolling of a finger 1132 on a specific notification in a notification list. Corresponding to this, the electronic device 101 may expand the item 1134 corresponding to the specific notification. Even if the user does not select the item corresponding to the specific notification, the electronic device 101 may expand the item corresponding to the specific notification so as to identify the contents of the corresponding notification in detail through sensing of the rolling of the fingerprint. Through this, even if the application is not executed through direct selection of the notification item, the contents of the notification can be identified more conveniently through the feature information of the fingerprint.

According to various embodiments, the electronic device 101 may expand and display all of the entire notification items corresponding to the rolling of the fingerprint in addition to the notification corresponding to the area where the user's fingerprint is located.

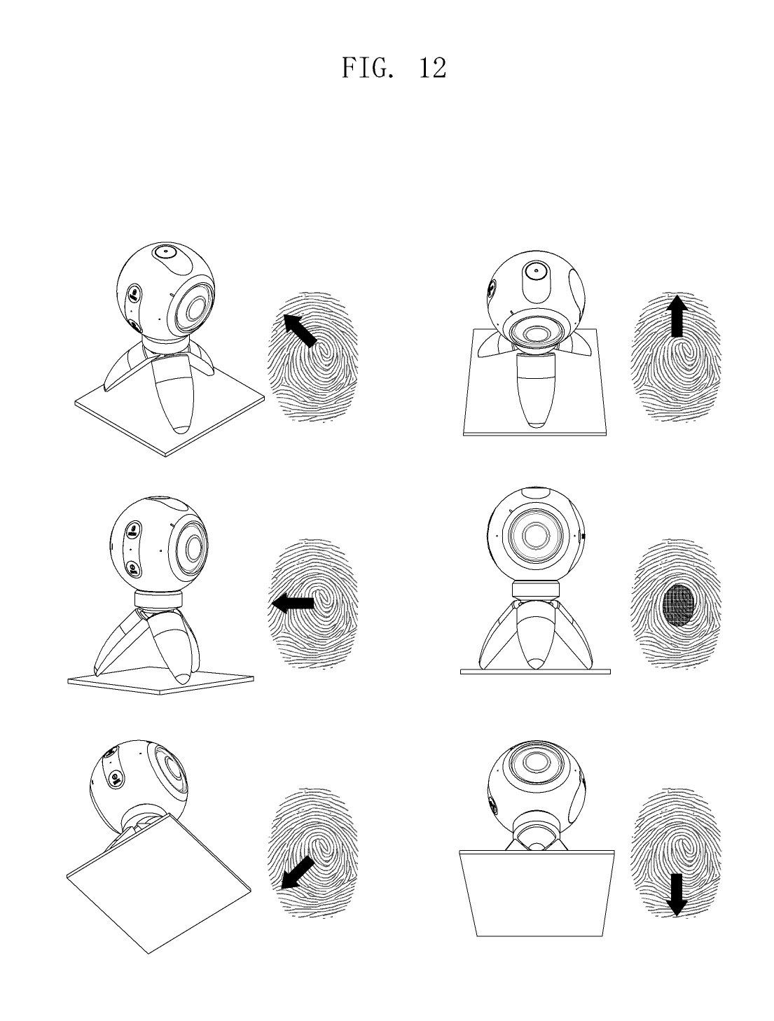

FIG. 12 is a diagram illustrating a method in which an application of the electronic device stereoscopically displays an object through an input of a fingerprint, according to various embodiments.

Referring to FIG. 12, an arrow may indicate movement of a contact formed between a user's fingerprint and a touch sensor or a display 260. Since a portion that comes in contact with the display 260 is changed through rolling of a finger, the electronic device 101 may stereoscopically display an object based on the changed.

According to various embodiments, if the user touches the display with the side portion of the fingerprint without using the rolling of the fingerprint, the electronic device 101 may directly display a three-dimensional area of an object corresponding to the contact.

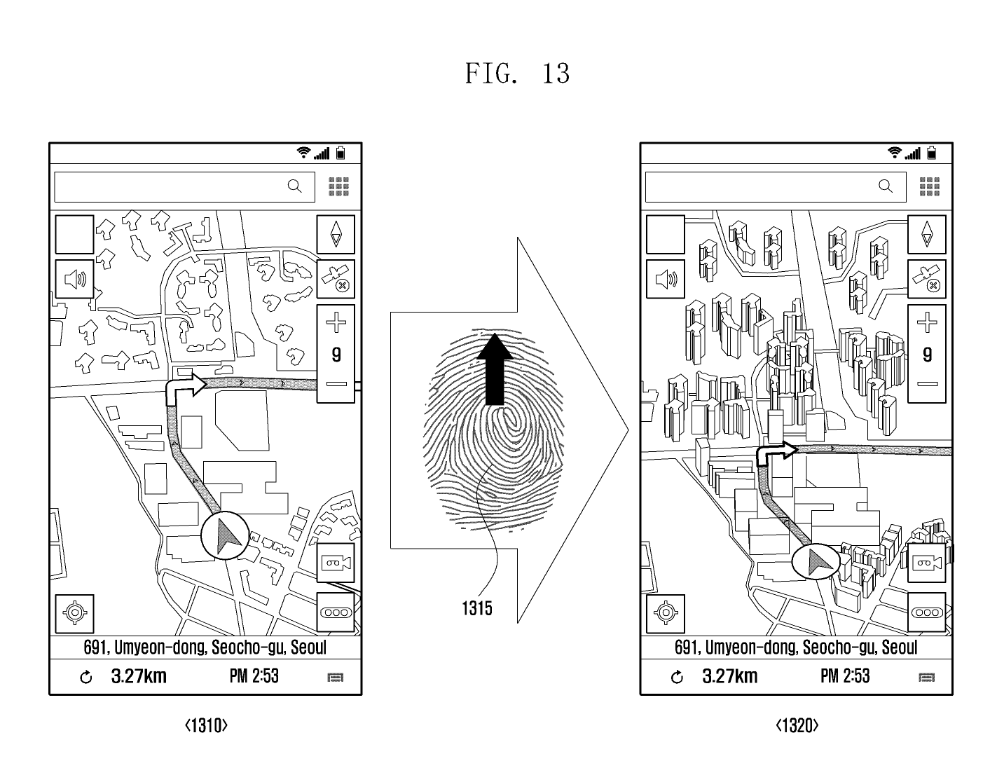

FIG. 13 is a diagram illustrating a method in which an application of the electronic device stereoscopically displays a geographical element through an input of a fingerprint, according to various embodiments.

Referring to FIG. 13, the electronic device 101 may switch a screen of a two-dimensional viewpoint to a screen of a three-dimensional viewpoint through a fingerprint input (e.g., rolling) in an application including geographical elements (e.g., map or navigation).

Referring to 1310 of FIG. 13, it can be identified that geographical elements are displayed in two dimensions through a navigation application. The electronic device 101 may stereoscopically display the geographical constituent elements in three dimensions as illustrated in 1320 of FIG. 13 by sensing rolling 1315 of the fingerprint. The electronic device 101 may display the geographical elements by adjusting an angle for displaying the geographical elements corresponding to the rolling 1315 of the fingerprint.

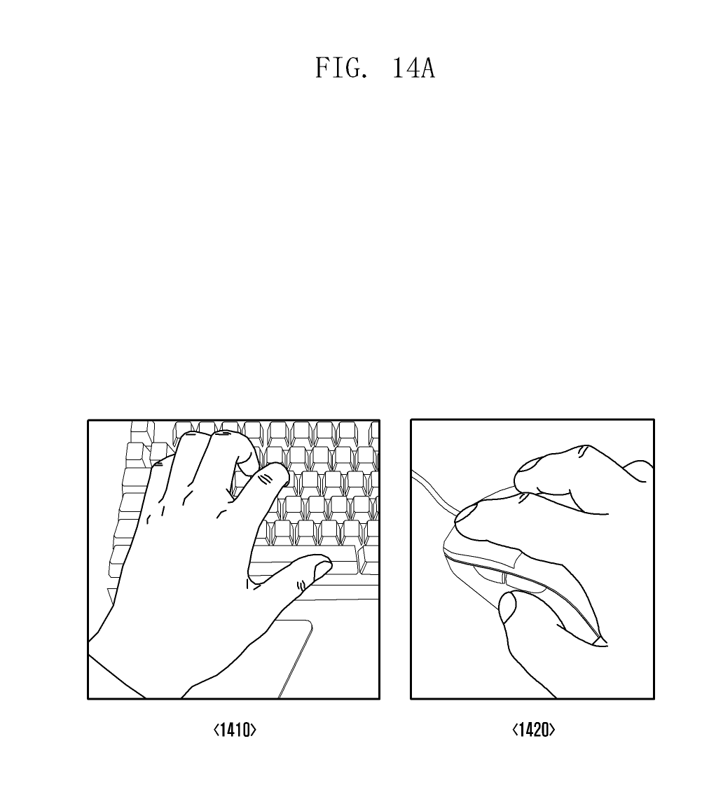

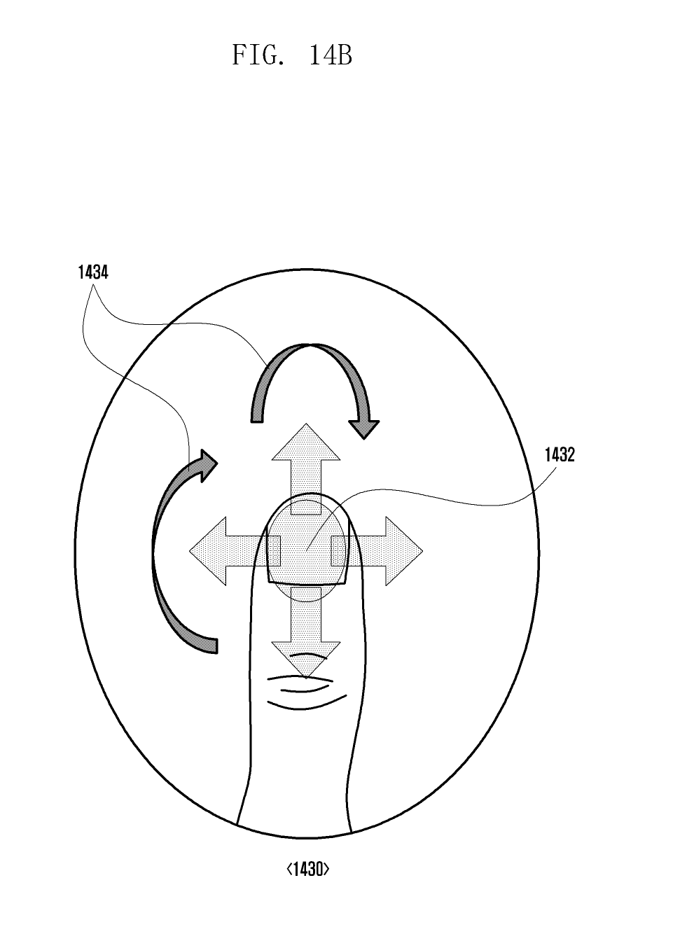

FIGS. 14A and 14B are diagrams illustrating a method in which an electronic device simultaneously performs location movement and viewpoint movement through an input of a fingerprint, according to various embodiments.

Referring to FIG. 14A, a device, such as a computer, may implement location movement and viewpoint movement in a three-dimensional space using a keyboard 1410 and a mouse 1420. In a three-dimensional game, the location may be moved through the keyboard 1410, and the viewpoint may be moved through the mouse 1420. That is, the location movement and the viewpoint movement may be implemented by inputting two kinds of operations.

Referring to item 1430 of FIG. 14B, the electronic device 101 may simultaneously implement the location movement and the viewpoint movement through fingerprint input.

According to various embodiments, in implementing a three-dimensional game through the electronic device 101, the location movement of an object (e.g., character) may be implemented by coordinate movement 1432 of the contact on the display. In the case where the coordinates of the contact actually move rather than rolling of the fingerprint in the touched area or in the neighborhood of the touched area, the location movement of the character can be performed.

According to various embodiments, in implementing the three-dimensional game through the electronic device 101, the viewpoint movement of the object (e.g., character) may be implemented by rolling 1434 of the fingerprint on the display. Through the rolling of the fingerprint in the touched area or in the neighborhood of the touched area, the viewpoint movement of the character can be performed.

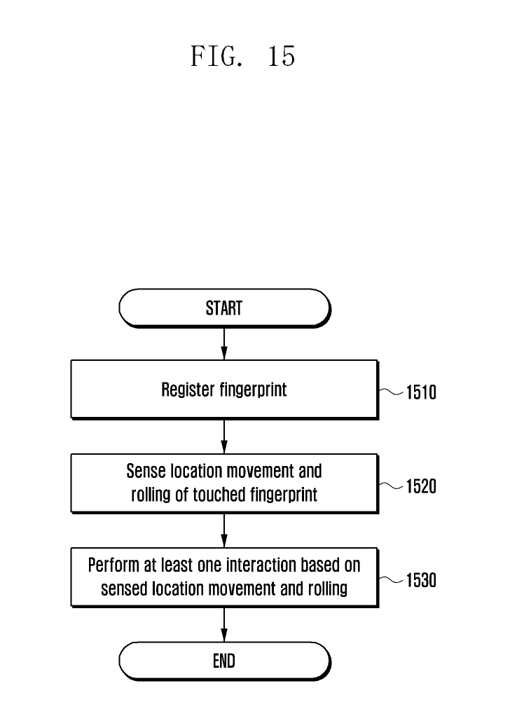

FIG. 15 is a flowchart illustrating a method in which an electronic device performs at least one interaction by sensing location movement and rolling of a fingerprint, according to various embodiments.

Referring to FIG. 15, the electronic device 101, at step 1510, may register a user's fingerprint. The electronic device 101 may be electrically or functionally connected to a fingerprint sensor or a display 260 to acquire information on the user's fingerprint.

According to various embodiments, the electronic device 101 may perform stereoscopic formation (or shaping) of the fingerprint based on information on the fingerprint, and may store feature information (e.g., stereoscopic information or shape information) on the fingerprint. The information on the fingerprint may include minutiae of the input fingerprint. For example, the minutiae relate to a primary feature made by a ridge and a valley of the fingerprint, and may include a ridge end at which the ridge of the fingerprint is discontinued, a bifurcation of the fingerprint, a core of the fingerprint, and a delta of the fingerprint. The electronic device 101 may receive the fingerprint input once or a plurality of times from a user for the stereoscopic formation of the fingerprint.

At step 1520, the electronic device 101 may sense the location and rolling of a touched fingerprint.

According to various embodiments, the electronic device 101 may sense the user's fingerprint put on the fingerprint sensor or the display 260. The electronic device 101 may be electrically or functionally connected to the fingerprint sensor or the display 260 to acquire information on the input fingerprint.

According to various embodiments, the electronic device 101 may identify to what area (or portion) of a pre-stored fingerprint the sensed (or input) fingerprint corresponds based on the feature information of the pre-stored fingerprint. If a user inputs his/her fingerprint with the fingertip kept upright, the electronic device 101 may identify that a fingerprint corresponding to the front end portion of the feature information of the pre-stored fingerprint has been input.

According to various embodiments, the electronic device 101 may sense rolling of the fingerprint. The electronic device 101 may identify that movement of the input fingerprint (e.g., movement of the ridge) from a first minutiae to a second minutiae have occurred based on the feature information of the pre-registered fingerprint. The electronic device 101 may acquire information on the continuous movement (e.g., direction of inclination and degree of inclination) of a touched contact (e.g., contact between the fingerprint sensor and the finger).

According to various embodiments, in sensing the rolling of the fingerprint, the electronic device 101 may determine the degree of rolling based on the contact during an initial touch. Further, in sensing the rolling of the fingerprint, the electronic device 101 may determine the degree of rolling based on the core of the pre-registered fingerprint. On the other hand, in case of sensing the rolling, the electronic device 101 may set up the existence of the contact as a trigger, or, if the contact area satisfies a predetermined width, space, location, etc., the electronic device 101 may set up such a condition as a trigger.

At step 1530, the electronic device 101 may perform at least one interaction based on the location and the rolling of the touched fingerprint.

According to various embodiments, the electronic device 101 may perform various interactions based on the area in which the sensed fingerprint belongs to the feature information of the pre-stored fingerprint. The electronic device 101 may perform interactions, such as location movement and viewpoint adjustment, based on the sensed fingerprint at step 1520.

According to various embodiments, the electronic device 101 may perform various interactions based on the rolling of the fingerprint. The electronic device 101 may perform an interaction of the viewpoint adjustment based on the rolling of the sensed fingerprint (e.g., rotation of the finger).

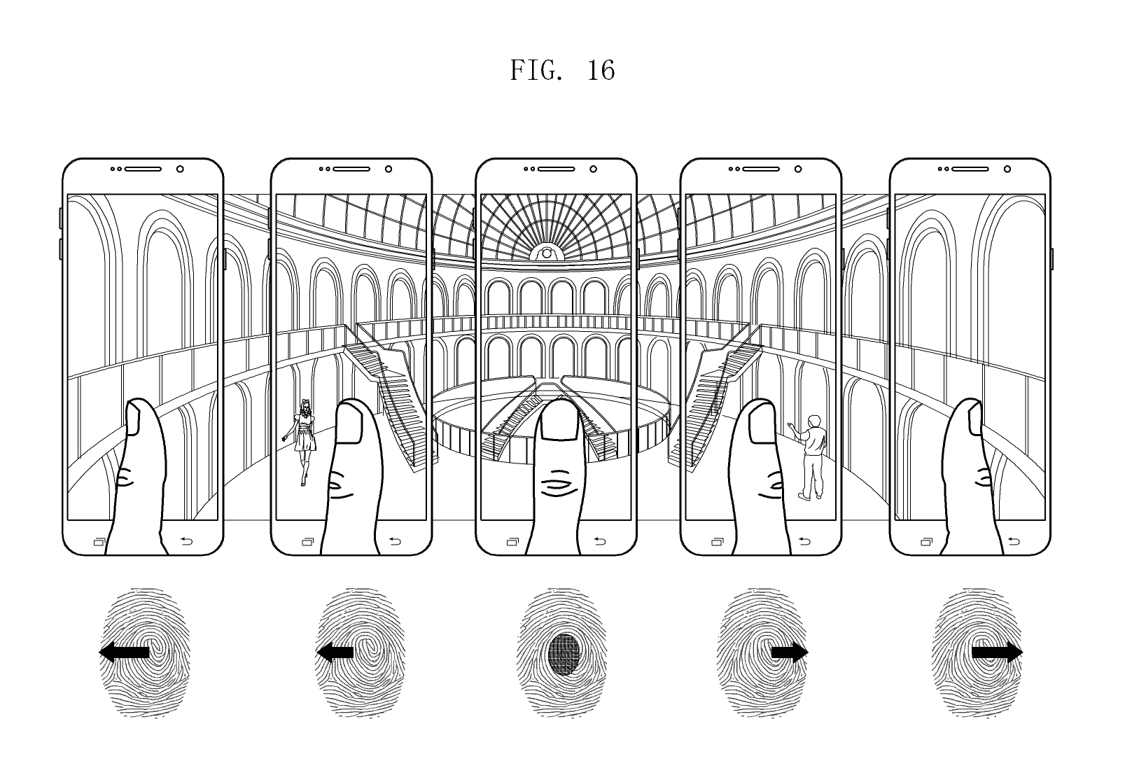

FIG. 16 is a diagram illustrating a method in which an electronic device adjusts a viewpoint in a stereoscopic space through an input of a fingerprint, according to various embodiments.

Referring to FIG. 16, the electronic device may sense rolling of a fingerprint, and through this, it may adjust the viewpoint in a three-dimensional space. For example, the electronic device may implement rotation by 180° or 360° in the three-dimensional space in accordance with the degree of inclination of the fingerprint. Through this, the electronic device 101 can provide an effect as if a user looks around the surroundings in the corresponding three-dimensional space only through the rolling of the finger.

According to various embodiments, an electronic device includes a fingerprint sensor; and a processor. The processor is configured to receive a first input about a fingerprint from a user, to register feature information on the fingerprint based on the first input, to receive a second input about at least a part of the fingerprint from the user, to identify location information on to what portion in the feature information at least the part of the fingerprint corresponding to the second input corresponds based on the second input, and to perform at least one interaction based on the location information.

The processor may be configured to receive the first input at least once from the user in order to register the feature information, and the feature information is generated based on minutiae of the fingerprint.

The second input may include information on a contact between the fingerprint and the fingerprint sensor.

The processor may be configured to sense coordinate movement of the contact, to perform location movement of a three-dimensional object based on the coordinate movement, and to perform viewpoint movement of the three-dimensional object based on the location information.

The processor may be configured to receive at least a part of the fingerprint corresponding to the contact as the second input if a width of the contact is greater than or equal to a predetermined width.

The second input may include rolling of the fingerprint, the second input may include an input of minutiae of the fingerprint that is changed as the rolling is successively performed, and the location information may be changed corresponding to the change of the input minutiae.

The processor may be configured to adjust a viewpoint to look at an object in three dimensions corresponding to the rolling.

The processor may be configured to perform a tab function in a web application corresponding to the rolling.

The processor may be configured to display detailed contents by expanding an item displayed in a notification list corresponding to the rolling.

The processor may be configured to perform an index function in a contact application corresponding to the rolling.

According to various embodiments, a method for an electronic device includes receiving a first input about a fingerprint from a user; registering feature information on the fingerprint based on the first input; receiving a second input about at least a part of the fingerprint from the user; identifying location information on to what portion in the feature information at least the part of the fingerprint corresponding to the second input corresponds based on the second input; and performing at least one interaction based on the location information.

The method may further include receiving the first input at least once from the user in order to register the feature information, and the feature information may be generated based on minutiae of the fingerprint.

The second input may include information on a contact between the fingerprint and the fingerprint sensor.

The method may further include sensing coordinate movement of the contact; performing location movement of a three-dimensional object based on the coordinate movement; and performing viewpoint movement of the three-dimensional object based on the location information.

The method may further include receiving at least a part of the fingerprint corresponding to the contact as the second input if a width of the contact is greater than or equal to a predetermined width.

The second input may include rolling of the fingerprint, the second input may include an input of minutiae of the fingerprint that is changed as the rolling is successively performed, and the location information may be changed corresponding to the change of the input minutiae.

The method may further include adjusting a viewpoint to look at an object in three dimensions corresponding to the rolling.

The method may further include performing a tab function in a web application corresponding to the rolling.

The method may further include displaying detailed contents by expanding an item displayed in a notification list corresponding to the rolling.

The method may further include performing an index function in a contact us application corresponding to the rolling.

Various embodiments disclosed herein are provided merely to easily describe technical details of the present disclosure and to help the understanding of the present disclosure, and are not intended to limit the scope of the present disclosure. Accordingly, the scope of the present disclosure should be construed as including all modifications or various other embodiments based on the technical idea of the present disclosure as defined in the appended claims and their equivalents.

What is claimed is:

1. An electronic device comprising:
a fingerprint sensor; and
a processor configured to:
receive a first input of a fingerprint from a user,
register, based on the first input, feature information corresponding to the fingerprint,
after registering the feature information, receive a second input of at least a part of the fingerprint from the user,
identify, based on the second input, location information on at least the part of the fingerprint, corresponding to the second input, that corresponds to a portion in the feature information, and
perform at least one interaction based on the location information.

2. The electronic device of claim 1, wherein the processor is further configured to receive the first input at least once from the user in order to register the feature information, and
wherein the feature information is generated based on minutiae of the fingerprint.

3. The electronic device of claim 1, wherein the second input comprises information on a contact between the fingerprint and the fingerprint sensor.

4. The electronic device of claim 3, wherein the processor is further configured to:
sense coordinate movement of the contact,
perform location movement of a three-dimensional object based on the coordinate movement, and
perform viewpoint movement of the three-dimensional object based on the location information.

5. The electronic device of claim 3, wherein the processor is further configured to receive at least a part of the fingerprint corresponding to the contact as the second input if a width of the contact is greater than or equal to a predetermined width.

6. The electronic device of claim 1, wherein the second input includes rolling of the fingerprint,
wherein the second input includes an input of minutiae of the fingerprint that is changed as the rolling is successively performed, and
wherein the location information is changed corresponding to the change of the input minutiae.

7. The electronic device of claim 6, wherein the processor is further configured to:
adjust a viewpoint to look at an object in three dimensions corresponding to the rolling.

8. The electronic device of claim 6, wherein the processor is further configured to:
perform a tab function in a web application corresponding to the rolling.

9. The electronic device of claim 6, wherein the processor is further configured to:
display detailed contents by expanding an item displayed in a notification list corresponding to the rolling.

10. The electronic device of claim 6, wherein the processor is further configured to:
perform an index function in a contact application corresponding to the rolling.

11. A method for an electronic device comprising:
receiving a first input of a fingerprint from a user;
registering, based on the first input, feature information corresponding to the fingerprint;
receiving a second input of at least a part of the fingerprint from the user, after registering the feature information;
identifying, based on the second input, location information on at least the part of the fingerprint, corresponding to the second input, that corresponds to which portion in the feature information; and
performing at least one interaction based on the location information.

12. The method of claim 11, further comprising:
receiving the first input at least once from the user in order to register the feature information,
wherein the feature information is generated based on minutiae of the fingerprint.

13. The method of claim 11, wherein the second input comprises information on a contact between the fingerprint and the fingerprint sensor.

14. The method of claim 13, further comprising:
sensing coordinate movement of the contact;
performing location movement of a three-dimensional object based on the coordinate movement; and
performing viewpoint movement of the three-dimensional object based on the location information.

15. The method of claim 13, further comprising:
receiving at least a part of the fingerprint corresponding to the contact as the second input if a width of the contact is greater than or equal to a predetermined width.

16. The method of claim 11, wherein the second input includes rolling of the fingerprint,
wherein the second input includes an input of minutiae of the fingerprint that is changed as the rolling is successively performed, and
wherein the location information is changed corresponding to the change of the input minutiae.

17. The method of claim 16, further comprising:
adjusting a viewpoint to look at an object in three dimensions corresponding to the rolling.

18. The method of claim 16, further comprising:
performing a tab function in a web application corresponding to the rolling.

19. The method of claim 16, further comprising:
displaying detailed contents by expanding an item displayed in a notification list corresponding to the rolling.

20. The method of claim 16, further comprising:
performing an index function in a contact us application corresponding to the rolling.
